(19) United States
(12) Patent Application Publication
(10) Pub. No.: US 2015/0121291 A1
(43) Pub. Date: Apr. 30, 2015

(54) Input Method Editor

(71) Applicants: Matthew Robert Scott, Beijing (CN); Huihua Hou, Beijing (CN); Weipeng Liu, Beijing (CN); Weijiang Xu, Beijing (CN)

(72) Inventors: Matthew Robert Scott, Beijing (CN); Huihua Hou, Beijing (CN); Weipeng Liu, Beijing (CN); Weijiang Xu, Beijing (CN)

(73) Assignee: Microsoft Corporation, Redmond, WA (US)

(21) Appl. No.: 13/635,306

(22) PCT Filed: Jun. 29, 2012
(86) PCT No.: PCT/CN2012/077855

§ 371 Date: Sep. 14, 2012

(51) Int. Cl. G06F 3/023; G06F 3/0484; G06F 17/24; G06F 3/0482

(52) U.S. Cl. CPC G06F 3/0237; G06F 3/0482; G06F 3/04842; G06F 17/24; G06F 3/0236
USPC 715/780

(57) ABSTRACT

An input method editor (IME) may include a normal mode and a rich candidate mode. The IME may present text candidates in response to receiving user inputs in the normal mode, and rich text candidates in addition to the text candidates in response to receiving user inputs in the rich candidate mode.

### CROSS REFERENCE TO RELATED APPLICATIONS

This application is a 35 U.S.C. 371 National Stage Application of International Application No. PCT/CN2012/077855, filed Jun. 29, 2012, the entire contents of which are incorporated herein by reference.

### TECHNICAL FIELD

This disclosure relates generally to an input method editor (IME), and more particularly, to an IME with multiple operating modes.

### BACKGROUND

An input method editor (IME) is a computer functionality that assists a user to input text into a host application of a computing device. An IME may provide several suggested words and phrases based on received inputs from the user as candidates for insertion into the host application. For example, the user may input one or more initial characters of a word or phrase and an IME, based on the initial characters, may provide one or more suggested words or phrases for the user to select a desired one.

For another example, an IME may also assist the user to input non-Latin characters such as Chinese. The user may input Latin characters through a keyboard. The IME returns one or more Chinese characters as candidates for insertion into the host application based on the spelling. The user may then select the proper character and insert it into the host application. As many typical keyboards support inputting Latin characters, the IME is useful for the user to input non-Latin characters using a Latin-character keyboard.

The candidates selected by the user can be inserted into various host applications, such as a chatting application, a document editing application, an email application, a drawing application, a gaming application, etc. Typically, an IME only provides candidates in the form of text, and a single source is typically used to identify the candidates, regardless of the type of application with which the IME is being used.

### DISCLOSURE OF THE INVENTION

This Disclosure of the Invention is provided to introduce a selection of concepts in a simplified form that are further described below in the Detailed Description. This Disclosure of the Invention is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the present disclosure.

Some implementations include an input method editor (IME) executable by a computing device. The IME may present candidates to a user for insertion into a host application. The IME may include multiple user selectable modes and may present different types of candidates depending on the mode selected by the user. As some examples, the IME includes a normal mode to present text candidates to the user and a rich candidate mode to present rich candidates, in addition to the text candidates, to the user. In other examples, the IME may include multiple rich candidate modes. Additionally, in some instances, the IME may provide the user inputs to one or more search engines and may utilize the search results as the rich candidates. The type of search and search engine used may vary depending on the rich candidate mode selected by the user.

### BRIEF DESCRIPTION OF THE DRAWINGS

The Detailed Description is described with reference to the accompanying figures. In the figures, the left-most digit(s) of a reference number identifies the figure in which the reference number first appears. The same numbers are used throughout the drawings to reference like features and components.

FIG. 1 is a block diagram of an example configuration of a computing device implementing an IME.

FIG. 2 is a block diagram of an example configuration of a computing device implementing IME in communication with one or more search engines.

FIG. 3 is a pictorial view of an example of a host application utilizing an IME according to some implementations.

FIG. 4 is a pictorial view of a second example of a host application utilizing an IME according to some implementations.

FIG. 5 is a pictorial view of a third example of a host application utilizing an IME according to some implementations.

FIG. 6 is a pictorial view of a fourth example of a host application utilizing an IME according to some implementations.

FIG. 7 is a pictorial view of a fifth example of a host application utilizing an IME according to some implementations.

FIG. 8 is a pictorial view of a sixth example of a host application utilizing an IME according to some implementations.

FIG. 9 is a flow diagram of an example process preformed by an IME according to some implementations.

### DETAILED DESCRIPTION

The disclosed techniques describe an input method editor (IME) that presents candidates to a user that may be selected by the user for insertion into a host application. The candidates presented to the user are based at least partly on a user selectable mode of the IME. The candidates may include text candidates such as non-Lain or Chinese characters and rich candidates such as multimedia to provide supplemental information to a user to enhance the user experience.

The user inputs are one or more texts such as characters or symbols input by the user into a composition window of the IME. The user inputs may represent one or more expressions or search queries. For example, a user input may be a series of initial characters, an abbreviation, a spelling, and/or a translation of one or more words or phrases. The user inputs and the expressions represented by the user inputs, such as words or phrases, may be in the same or different languages. The user may input the user inputs through a variety of input methods, such as a keyboard input, a voice input, a touch screen input, and/or gesture.

The text candidates are the expressions or queries represented by the user inputs in the form of text. The rich candidates are the expressions or queries represented by the user inputs in forms other than text such as web links, audio files, images, web pages, maps, and other multimedia.

The candidates may also be ranked according to their relevancies to the user inputs. In one example, such ranking may be accomplished by the IME. In another example, the ranking may be accomplished by one or more search engines, one or more search engine computing devices, or a combination of the IME, the one or more search engines, and/or the one or more search engine computing devices. The candidates may be ranked differently in different modes. There is also a preference towards different types of candidates in the different modes. In one example, the IME includes at least one mode that causes the IME to preference rich candidates over text candidates. In another example, the IME includes at least one mode that causes the IME to present the rich candidates and the text candidates in a mixed order.

The IME is capable of presenting both text candidates and rich candidates at a user interface of the IME. For example, the user interface of the IME may include a web browser component such as an embedded HTML window.

There may be various configurations of the IME to identify the candidates. In one example, the IME includes a communication interfaces to communicate with one or more user selectable search engines that are capable of producing specific types of text and/or rich candidates depending on the selected mode. For example, the user may place the IME in a web mode, and the IME may provide the user inputs to a search engine computing device which selects as search engine, such as Bing®, Google®, Yahoo®, Alibaba®, or the like, to receive rich candidates and/or text candidates from. The rich candidates may include, for example, web search results, video search results, image search results, audio file search results or dictionary and encyclopedia search results.

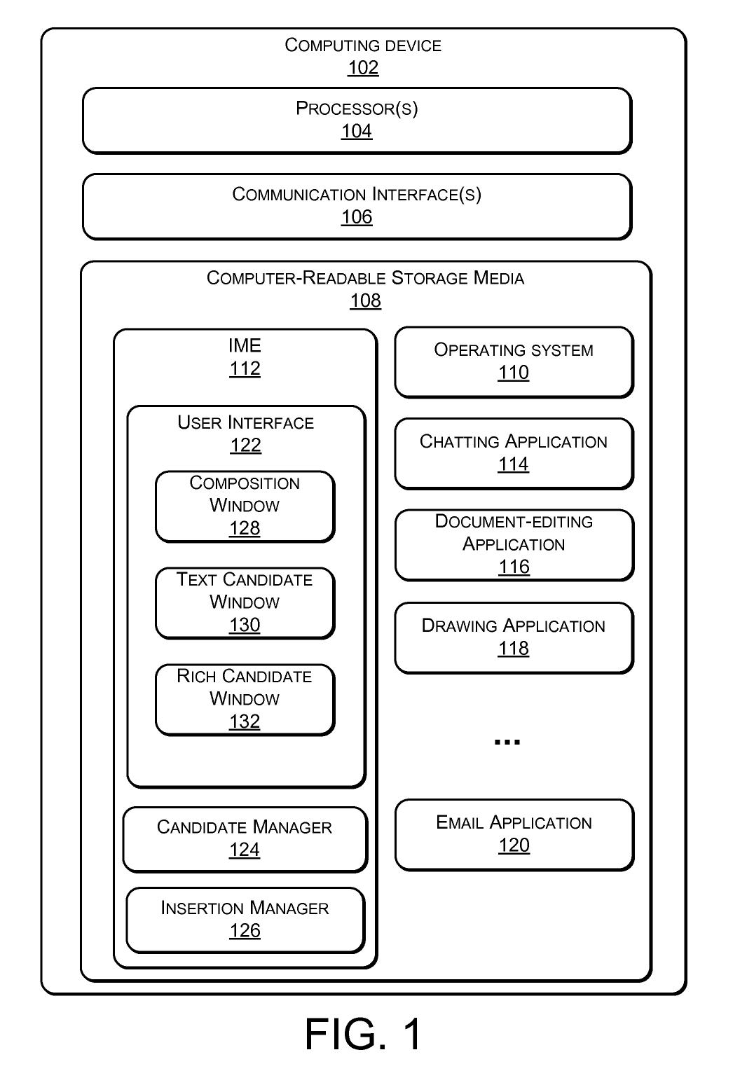

There may be various configurations of the IME. In one example, as shown in FIG. 1, all components of the IME are located on a computing device. In another example, some of the components of the IME may be located on the computing device, such as the user interface, and other components may be located on a remote server, such as a candidate manager. In another example, a search engine computing device may be located on the remote server, and the user interface of the IME may be located at the computer device.

FIG. 1 is a block diagram of an example configuration of a computing device 102 implementing an IME 112. Computing device 102 may, but need not, be used to implement the techniques described herein. Computing device 102 is one example and is not intended to suggest any limitation as to the scope of use or functionality of the computer and network architectures.

For the sake of convenient description, IME 112 is functionally divided into various modules which are separately described. When implementing the disclosed system, the functions of various modules may be implemented in one or more instances of software and/or hardware. Some modules of the IME 112 described below may be implemented as multiple separate systems or as combined systems and their processing results are used by the IME 112.

The components of computing device 102 include one or more processors 104, one or more communication interfaces 106, and one or more computer-readable media 108. Computer-readable storage media 108 includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by the computing device.

In contrast, communication media may embody computer readable instructions, data structures, program modules, or other data in a modulated data signal, such as a carrier wave, or other transmission mechanism. As defined herein, computer storage media does not include communication media.

Any number of program modules, applications, or components can be stored in the computer-readable storage media 108, including by way of example, an operating system 110, an input method editor (IME) 112, one or more host applications, such as the a chatting application 116, a document-editing application 114, a drawing application 118, and an email application 120, other program modules, program data, computer executable instructions.

The IME 112 stored in computer-readable storage media 108 and executable by processors 104 includes a user interface 122, a candidate manager 124, and an insertion manger 126. The user interface 122 includes a composition window 128 to receive inputs from the user, a text candidate window 130 to provide text candidates to the user, and a rich candidate window 132 to provide rich candidates to the user. For example, composition window 128 may be a text input window, text candidate window 130 may be a text box, and rich candidate window 132 may be an embedded HTML browser component. In other examples, one or more of the composition window 128, text candidate window 130, and rich candidate window 132 of user interface 122 may be combined into one or more combination window(s).

Candidate manager 124 manages the translation of user inputs into candidates. For example, candidate manager 124 may perform the operations of providing an auto complete feature, a spell checking feature, or a translation feature to provide text candidates. In another example, candidate manager 124 may perform various processes to select and provide the user inputs to one or more search engines and utilize the search results as the rich candidates. Candidate manger 124 may select the search engines based on one or more parameters, such the current mode of IME 112, data related to the host application, the type of candidates that are accepted by the host application, data related to computing device 102 executing the host application, data related to previous user inputs, data related to previous search history and user specified search engines, data related previous presented candidates, and/or data related to previously inserted candidates.

Insertion manger 126 manages the insertion of a selected candidate into the host application. Insertion manger 126 is aware of the types of candidates that a host application is capable of accepting and can convert an unacceptable candidates into an acceptable type before insertion. For example, insertion manager 126 may convert an HTML candidate into a text candidate before insertion.

In some examples, a user inputs characters into composition window 128. IME 112 monitors the user inputs as the characters are entered to determine if a predetermined input, or mode prefix string, which indicates that a rich candidate mode is to be enabled, has been entered into composition window 128. In some examples, IME 112 presents the user with a rich candidate mode menu, in response to detecting the predetermined input. The user may interact with the menu to further specify parameters related to the rich candidate mode, such as search engines to use, types of rich candidates to search for, etc.

In one particular example, IME 112 may include multiple rich candidate modes. Each rich candidate mode enables IME 112 to present different types of rich candidates to the user. For example, IME 112 may include a web mode, a map mode, a video mode, an audio mode, an image mode, in addition to various other types of rich candidate modes. In one particular example, IME 112 includes a web mode, which causes IME 112 to present text candidates including auto compete and spelling correction to text candidate window 130 and rich candidates including links to website related to the user inputs to rich candidate window 132. In another example, IME 112 includes a map mode, which cause IME 112 to present text candidates including auto compete and spelling correction to text candidate window 130 and rich candidates including at least one interactive map of a location related to the user inputs to rich candidate window 132.

The predetermined input may be a single character or a combination of characters entered in sequence. The predetermined input may also vary depending on, for example, language, host application, or rich candidate mode enabled. One or more predetermined inputs may be employed by IME 112 to enable multiple rich candidate modes, simultaneously, providing the user the ability to be presented with multiple types of rich candidate in response to a single user input.

In one example, IME 112 is used to translate pinyin text (Chinese characters represented in Latin script) into Chinese characters. In pinyin the character “v” is not utilized, therefore, IME 112 can be configured to detect the prefixed input of the character “v” at composition window 128 and, in response to detecting the input of the character “v”, cause IME 112 to enter a rich candidate mode. In the rich candidate mode, IME 112 enables rich candidate window 132 and causes candidate manager 124 to provide the user inputs to the search engine computing devices to acquire the rich candidates.

IME 112 may be further configured to detect the input of character “v” followed by a second character, such as “i”. When IME 112 detects the combination of characters “vi”, IME 112 enters a rich candidate mode, which searches for images as the rich candidates. Therefore, by configuring IME 112 to detect various combinations of characters that constitute a mode prefix string, the user is able to quickly and efficiently switch between rich candidate modes. It should be understood that other characters or combination of characters can be used to indicate other various rich candidate modes of IME 112 and that characters or combination of characters may vary for each rich candidate mode depending on language, user input method, keyboard type, host application, etc.

Upon the activation of a rich candidate mode, candidate manger 124 provides the user inputs to one or more search engine computing devices in order to receive rich candidates in response. In one example, the search engine may be selected by the user. In another example, the search engine may be selected by candidate manger 124 based in part on the current rich candidate mode of IME 112. In another particular example, candidate manger 124 may specify additional search parameters, such as type of search to perform e.g. an image search, based on the current rich candidate mode of IME 112.

Regardless of rich candidate mode, once IME 112 has presented candidates to the user at either text candidate window 130 or rich candidate window 132 the user is able to select one or more candidates for insertion into a host application, such as chatting application 114, document-editing application 116, drawing application 118, or email application 120 by insertion manager 126.

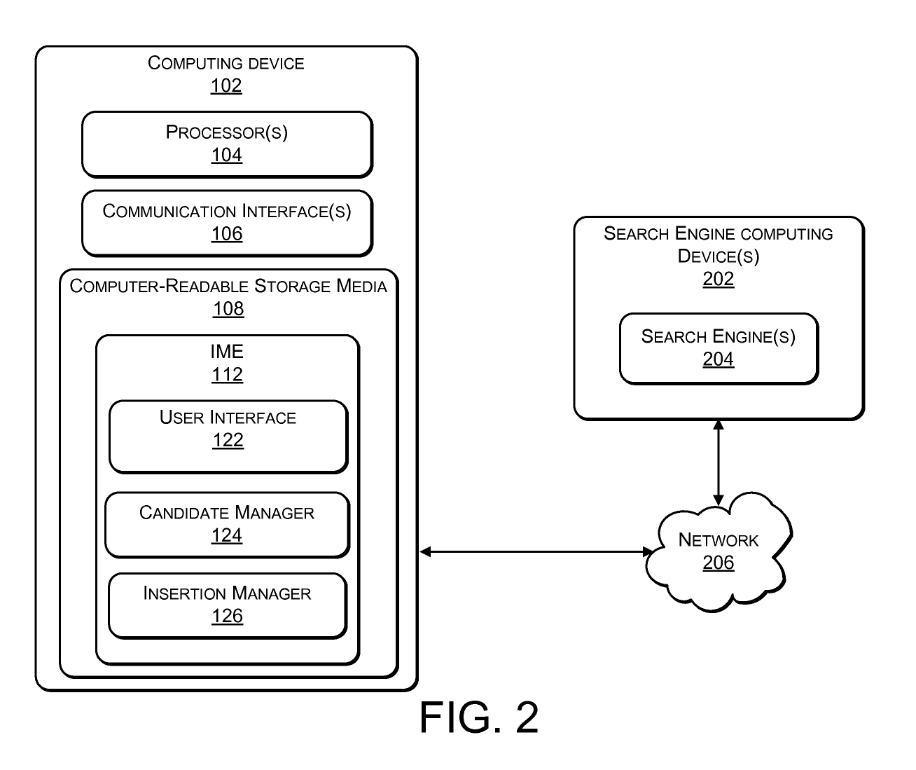

FIG. 2 is a block diagram of an example configuration of a computing device 102 implementing IME 112 of FIG. 1 in communication with one or more search engine computing devices 202. The components of computing device 102 include one or more processors 104, a communication interfaces 106, and computer-readable storage media 108.

Communication interfaces 106 are accessible by processors 104 to communicate data to and from the one or more search engine computing devices 202 over a network, such as network 206. Search engine computing devices 202 are configured to perform the search using one or more search engines 204. Search engines 204 may be a generic search engine such as Bing®, Google®, or Yahoo®, a combination of search engines, or a custom search engine configured to operate in conjunction with IME 112 (such as a translation engine). Search engines 204 may also be a specialized form of a search engine such as Bing® Maps or Google® image search.

The IME 112 stored in computer-readable storage media 108 and executable by processors 104 includes a user interface 122, a candidate manager 124, and an insertion manger 126. The user interface 122 receives user inputs and presents candidates for insertion into a host application as described above with respect to FIG. 1.

Candidate manager 124 manages the translation of user inputs into candidates. For example, candidate manager 124 may perform the operations of providing an auto complete feature, a spell checking feature, or a translation feature to provide text candidates. In another example, candidate manager 124 may perform various processes to select the search engines 202 to provide the user inputs based on one or more parameters.

Insertion manger 126 manages the insertion of a selected candidate into the host application. Insertion manger 126 is aware of the types of candidates that a host application is capable of accepting and can convert an unacceptable candidates into an acceptable type before insertion. For example, insertion manager 126 may convert an HTML candidate into a text candidate before insertion.

In some examples, a user inputs characters into computing device 102. IME 112 monitors the user inputs as the characters are entered to determine if a predetermined input, indicating that a rich candidate mode is to be enabled, has been entered. In some examples, IME 112 provides the user a rich candidate mode menu at user interface 122, in response to detecting the predetermined input. The user may interact with the menu to further specify parameters related to the rich candidate mode, such as search engines to use, types of rich candidates to search for, etc.

In some examples, a rich candidate mode is selected by the user, which causes candidate manger 124 to utilize communication interfaces 106 to provide the user inputs to search engine computing devices 202. Search engine computing devices 202 are then able to provide the user inputs (or modified user inputs) to one or more search engines 204 to perform the search. Search engine computing devices 202 may also order, combine, or otherwise refine the search results received from search engines 204 before communicating the search results back to computing device 102. For example, search engine computing devices 202 may combine search results from more than one search engine by removing duplicate results. Communication interfaces 106, receives the search results from search engine computing devices 202 to be presented as rich candidates, in response. Search engines 204 are user selectable and the user is able to further specify search parameters via user interface 122 to further tailor the search results received. In an alternative example, search engine 204 may be selected by candidate manger 124 based in part on the current rich candidate mode of IME 112.

It should be understood that IME 112 may be used in an environment or in a configuration of universal or specialized computer systems. Examples include a personal computer, a server computer, a handheld device or a portable device, a tablet device, a multi-processor system, a microprocessor-based system, a set-up box, a programmable customer electronic device, a network PC, and a distributed computing environment including any system or device above.

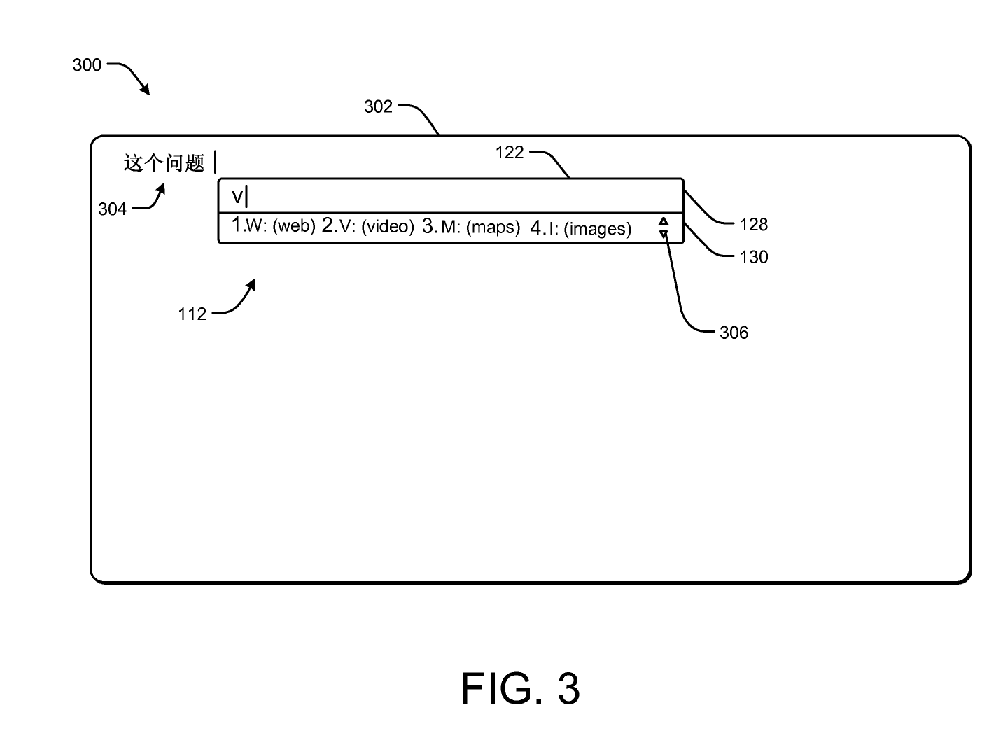

FIGS. 1 and 2 provide an example framework for implementing IME 112. The following FIGS. 3-8 provide example user interfaces that may be implemented using IME 112 to demonstrate example rich candidate modes of IME 112.

FIG. 3 is a pictorial view of an example 300 of host application 302 utilizing an IME according to some implementations herein. Host application 302 is shown here as a document-editing application. Host application 302 may also be chatting application, a drawing application, an email application, or various other applications.

Host application 302 includes text insertion area, generally indicated by 304. Text insertion area 304 includes characters inserted directly into the host application by the user or via IME 112. Text insertion area 304 also includes an input indication represented by “|,” which represents an indication of where the candidates are to be inserted into host application 302 by insertion manager 126. The input indication may be, for example, a focus of a mouse. The input indication also indicates which host application 302 of computer device 102 among many host applications running on computing device 102 that is to receive the candidates inserted by IME 112. In one particular example, multiple host applications may utilize the features of IME 112 simultaneously and the user may switch between one or more of the host applications to receive the candidates by moving the input indication between the host applications.

IME 112 is shown as user interface 122, which includes composition window 128 for receiving user inputs and text candidate window 130 for displaying text candidates to the user. Text candidate window 130 is also shown including pervious and next candidate arrows 306, which the user can interactive with to receive additional text candidates not currently shown in text candidate window 130.

In the illustrated example, the user is translating pinyin characters into Chinese characters and the user has entered the character “v” into composition window 128. As discussed above, the character “v” is not utilized in pinyin. In this example, the user has entered the character “v” to activate rich candidate mode of IME 112. Upon detecting that the character “v” was entered, IME 112 presents in text candidate window 130 a rich candidate mode menu.

The menu options presented, in response to detecting the character “v”, include options to enter rich candidate modes rather than the typical translations or auto correct candidates associated with text candidate window 130. As illustrated, the rich candidate modes include web mode, video mode, map mode, and image mode. Web mode is a rich candidate mode where the rich candidates include web search results, such as interactive web links. Video mode is a rich candidate mode where the rich candidates include video search results, such as video clips or movies. Map mode is a rich candidate mode where the rich candidates include location search results, such as a Bing map® including location indictor arrows. Image mode is a rich candidate mode where the rich candidates include image search results, such as jpeg files.

In some examples, the user may enter one of the rich candidate modes by either entering the corresponding number “1” for web mode, “2” for video mode, “3” for map mode, or “4” for image mode or by entering the indicated character “w” for web mode, “v” for video mode, “m” for map mode, or “i” for image mode followed by, in this case, a colon. For example, if the user enters “vw:”, IME 112 enables web mode. In another example, the user may enter “v1”, to again cause IME 112 to enable web mode. In other examples, the user may enter either “vi:” or “v4” to enter image mode or “vm:” or “v2” to enable map mode.

While four rich candidate modes are illustrated, more than four rich candidate modes may be available. For example, IME 112 may include an audio mode e.g. a rich candidate mode where the rich candidates include audio files, such as mp3 files. By interacting with the pervious and next candidate arrows 306, the user may gain access to these additional rich candidate modes at the rich candidate mode menu.

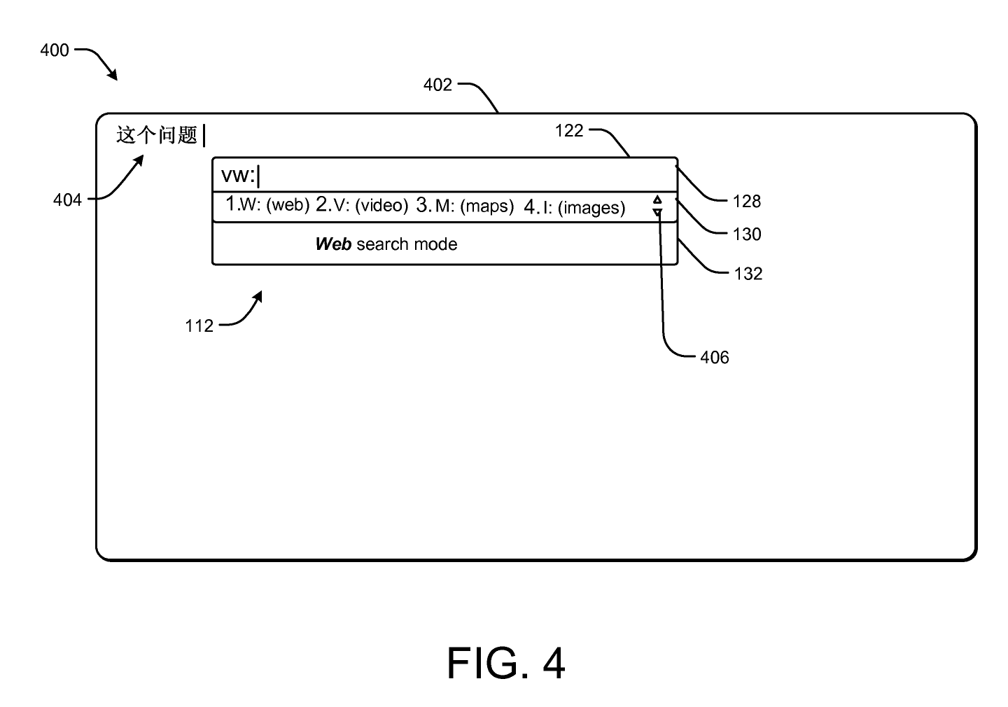

FIGS. 4-8 below provide additional examples of user interface 122 of IME 112 to further clarify the operations related to IME 112.

FIG. 4 is a pictorial view of a second example 400 of host application 302 utilizing an IME according to some implementations herein. In the illustrated example, IME 112 is again operating to insert Chinese characters into host application 402 using pinyin spellings. Host application 402 is a shown here as a document-editing application. Host application 402 may also be chatting application, a drawing application, an email application, or various other applications.

Host application 402 includes text insertion area, generally indicated by 404. Text insertion area 404 f device 102 that is to receive the candidates inserted by IME 112, as discussed above with respect to FIG. 2.

IME 112 is shown as user interface 122, which includes composition window 128 for receiving user inputs, text candidate window 130 for presenting text candidates to the user, and rich candidate window 132 for presenting rich candidates to the user. Text candidate window 130 is also shown including pervious and next candidate arrows 406, which the user can interact with to receive additional text candidates not currently shown in text candidate window 130.

In the illustrated example, the user has entered the text “vw:”. As discussed above, entering “vw:” causes IME 112 to enable web mode. When web mode is activated, user interface of IME 112 presents rich candidates in rich candidate window 132 to the user. However, in the illustrated example, the user has not entered any text following “vw:”. Thus, text candidate window 130 continues to provide the rich candidate mode menu, which the user can use to enter alternative rich candidate modes. For example, if the user selected “2”, “3”, or “4” at this time IME 112 exits web mode and enters the corresponding rich candidate mode e.g. video mode, map mode, or image mode. Thus, the user is able to quickly and seamlessly switch between various rich candidate modes without an interruption in typing. In one particular example, IME 112 may be placed in a non-mixed rich candidate mode, such that only one type of rich candidate is displayed in rich candidate window 132.

Additionally as IME 112 is awaiting user inputs to search, rich candidate window 132 presents the text “Web search mode” to the user. Rich candidate window 132 is indicating to the user that IME 112 is in web mode and searches for rich candidates using a search engine. While this text is displayed, the user is able to select other search engines. In the illustrated example, the user may select the text “Web search mode” to bring up a search engine selection menu (not shown), which allows the user to select other search engines in addition to specifying search engine parameters.

In some examples, the user enters a user input following the text “vw:” in composition window 128. In response, text candidate window 130 presents text candidates, and rich candidate window 132 presents rich candidates, which are returned to IME 112 as results of a web search performed by the search engine. In one example, rich candidate window 132 may not be displayed if no rich candidates are returned. The text candidates and rich candidates presented are updated in real time, such that as the user enters additional text into composition window 128 the text candidates and rich candidates are updated. In an alternative example, text candidate window 130 and rich candidate window 132 may update candidates in response to the user entering a specific key, such as the “enter” key.

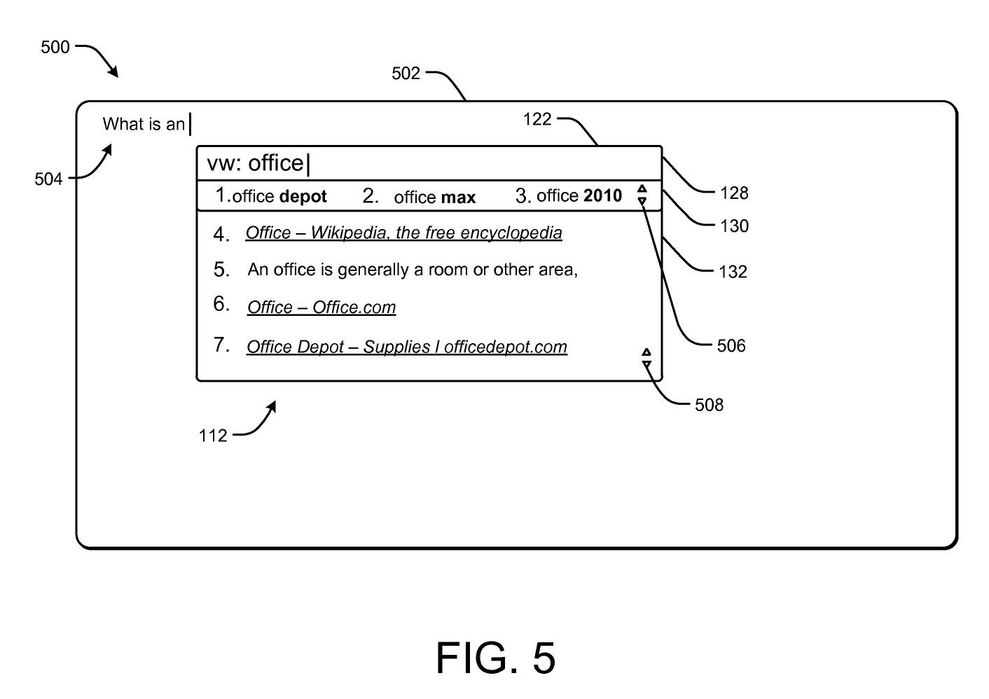

FIG. 5 is a pictorial view of a third example 500 of host application 502 utilizing an IME according to some implementations herein. In the illustrated example, IME 112 is operating to insert English words into host application 502. Host application 502 is a shown here as a document-editing application. Host application 502 may also be chatting application, a drawing application, an email application, or various other applications.

Host application 502 includes text insertion area, generally indicated by 504. Text insertion area 504 includes characters inserted by the user or via IME 112 into the host applicant. Text insertion area 504 also includes an input indication represented by “|,” which represents an indication of where the candidates are to be inserted into host application 502 by insertion manager 126. The input indication may be, for example, a focus of a mouse. The input indication also indicates which host application 502 of computer device 102 among many host applications running on computing device 102 that is to receive the candidates inserted by IME 112.

IME 112 is shown as user interface 122, which includes composition window 128 for receiving user inputs, text candidate window 130 for presenting text candidates to the user, and rich candidate window 132 for presenting rich candidates to the user. Text candidate window 130 is shown including pervious and next candidate arrows 506, which the user can interactive with to receive additional text candidates not currently shown in text candidate window 130. Rich candidate window 132 is also shown including a pervious and next candidate arrows 508, which the user can interactive with to receive additional rich candidates not currently displayed in rich candidate window 132.

In the illustrated example, the user has entered the text “vw: office”. As discussed above, entering “vw:” causes IME 112 to enable web mode. It should be noted that the “vw:” is ignored during the candidate selection process, such as when IME 112 provides the user input to a search engine or search engine computing device. Text candidate window 130, therefore, is presenting auto complete responses to the text “office”, rather than “vw: office”. Shown in the illustrated example as options 1-3 corresponding to the text “office depot”, “office max”, and “office 2010”. Additional auto complete options are available via pervious and next candidate arrows 506.

Rich candidate window 132 is also shown as presenting web search resulting from the text “office”. In the illustrated example, rich candidate window 132 displays options 5-8 corresponding to a link to Wikipedia®, the definition of office, a link to office.com, and a link to officedepot.com, respectively. Additional web search results are available via pervious and next candidate arrows 508.

In some examples, the user may cause IME 112 to insert the candidates into the text insertion area 504. For example, the text “office depot” may be inserted into host application 502 by entering “1” or the link to Wikipedia® may be inserted into host application 502 as a web link by entering “4”.

In one particular example, the user may move the auto complete options from text candidate window 130 to composition window 128 by, for example, holding shift while selecting one of options “1”, “2”, or “3”. By doing so, the user enables IME 112 to search the updated user input rather than the text “office” as shown. Thus, IME 112 is able to determine both text candidates and rich candidates based on the updated user input. For example if the user entered “1” while holding down the shift key, the text in the composition window 128 updates from “office” to “office depot” and the candidates update to reflect the text “office depot” rather than the text “office”.

After a user selection is made and IME 112 has inserted the corresponding candidate into host application 502, IME 112 clears composition window 128 and returns to normal mode to await the next user input. In this way, IME 112 enables the user to quickly switch between normal mode and rich candidate modes before every user input. In an alternative example, IME 112 may clear the user input but remain in web mode, for example, by clearing the text “office” but leaving the text “vw:” in composition window 128.

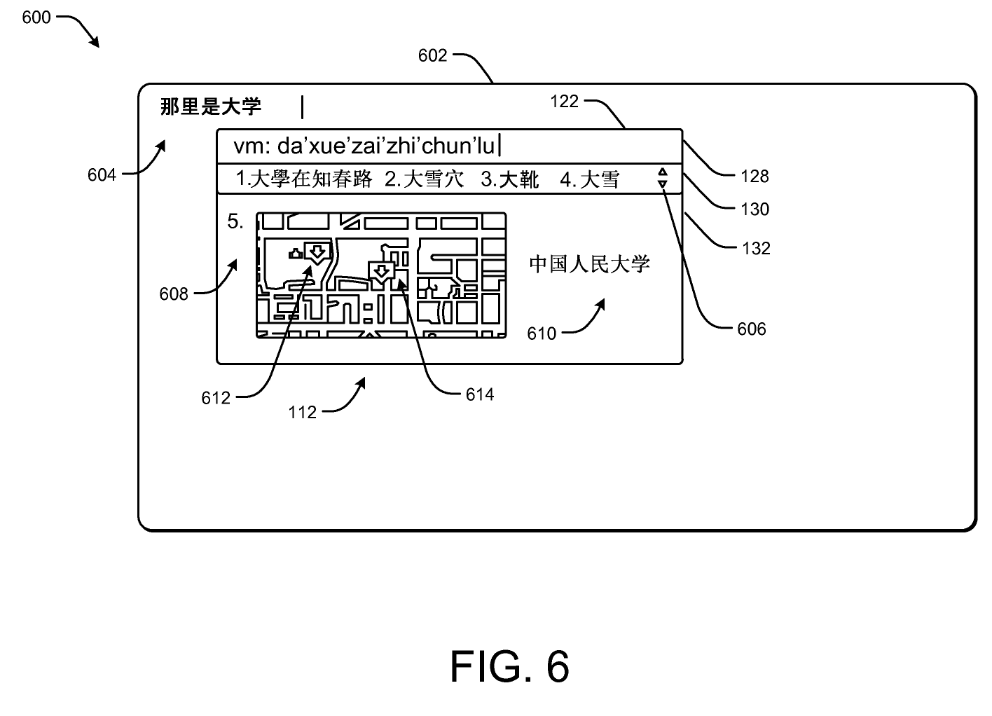

FIG. 6 is a pictorial view of a fourth example 600 of host application 602 utilizing an IME according to some implementations herein. In the illustrated example, IME 112 is again operating to insert Chinese characters into host application 602 using pinyin. Host application 602 is again shown as a document-editing application. Host application 602 may also be chatting application, a drawing application, an email application, or various other applications.

Host application 602 includes text insertion area, generally indicated by 604. Text insertion area 604 includes characters inserted by the user or via IME 112 into the host applicant. Text insertion area 604 also includes an input indication represented by “1,” which represents an indication of where the candidates are to be inserted into host application 602 by insertion manager 126. The input indication may be, for example, a focus of a mouse. The input indication also indicates which host application 602 of computer device 102 among many host applications running on computing device 102 that is to receive the candidates inserted by IME 112.

IME 112 is shown as user interface 122, which includes composition window 128 for receiving user inputs, text candidate window 130 for displaying text candidates to the user, and rich candidate window 132 for displaying rich candidates to the user. Text candidate window 130 is also shown including pervious and next candidate arrows 606, which the user can interactive with to receive additional text candidates not currently shown in text candidate window 130.

In the illustrated example, the user has entered the text “vm: da′xue′zai′zhi′chun′lu”. As a result of the user entering the text “vm:”, IME 112 is in map mode. While map mode is active, text candidate window 130 translates the pinyin text “da′xue′zai′zhi′chun′lu” into Chinese characters as discussed above. However, rich candidate window 132 presents the user with an interactive map 608 and corresponding descriptive text 610. Interactive map 608 includes arrows, generally indicated by 612 and 614, that are representing location search results returned from a search engine that correspond to the text “da′xue′zai′zhi′chun′lu”. By selecting either arrow 612 or 614, descriptive text 610 is updated to reflect a description of the currently selected location. Additionally, interactive map 608 may be scrolled to update the search results and presents additional location by, for example, grabbing and dragging the map in one direction. Examples of such interactive maps 608 include embedded HTML maps such as Bing map® provided by Microsoft® Inc.

In some examples, the user may cause IME 112 to insert the Chinese characters indicated in text candidate window 130 into host application 602 at text insertion area 604 by entering “1”, “2”, “3”, or “4”. The user may also cause IME 112 to insert an HTML map, a link to the location currently selected, or an image, such as a pdf or jpeg file, of the currently displayed area of a map by entering “5”. Whether or not an HTML map, a link, or an image of the map is inserted into host application 602 corresponds to the type of candidates host application 602 is capable of accepting. For example, an image of the map may be entered into a document-editing application while an HTML map may be inserted into a web browser application.

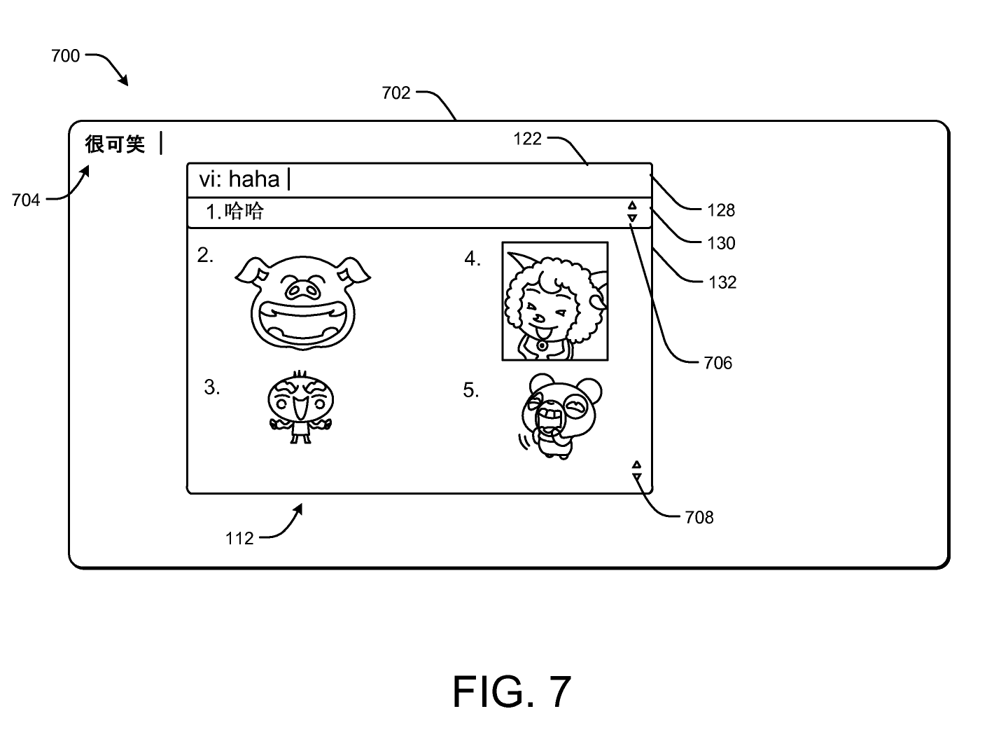

FIG. 7 is a pictorial view of a fifth example 700 of host application 702 utilizing an IME according to some implementations herein. In the illustrated example, IME 112 is again operating to insert Chinese characters into host application 702 using pinyin. Host application 702 is a shown here as a document-editing application. However, host application 702 may also be chatting application, a drawing application, an email application, or various other applications.

Host application 702 includes text insertion area, generally indicated by 704. Text insertion area 704 includes characters inserted by the user or via IME 112 into the host applicant. Text insertion area 704 also includes an input indication represented by “|,” which represents an indication of where the candidates are to be inserted into host application 702 by insertion manager 126. The input indication may be, for example, a focus of a mouse. The input indication also indicates which host application 702 of computer device 102 among many host applications running on computing device 102 that is to receive the candidates inserted by IME 112.

IME 112 is shown as user interface 122, which includes composition window 128 for receiving user inputs, text candidate window 130 for presenting text candidates to the user, and rich candidate window 132 for presenting rich candidates to the user. Text candidate window 130 is shown including pervious and next candidate arrows 706, which the user can interactive with to receive additional text candidates not currently shown in text candidate window 130. Rich candidate window 132 is also shown including a pervious and next candidate arrows 708, which the user can interactive with to receive additional rich candidates not currently shown in rich candidate window 132.

In the illustrated example, the user has entered the text “vi: haha”. As a result of the user entering “vi:”, IME 112 is in image mode. While in image mode, text candidate window 130 continues to translate the text “haha” from pinyin into Chinese characters. On the other hand, rich candidate window 132 is presenting image search results for the text “haha” to the user. As illustrated, rich candidate window 132 presents options 1-4 including images of various cartoon animals laughing.

In some examples, the user may cause IME 112 to insert either the Chinese characters indicated in text candidate window 130 into host application 702 at text insertion area 704 by entering “1” or an image as shown in rich candidate window 132 by entering “2”, “3”, “4”, or “5”.

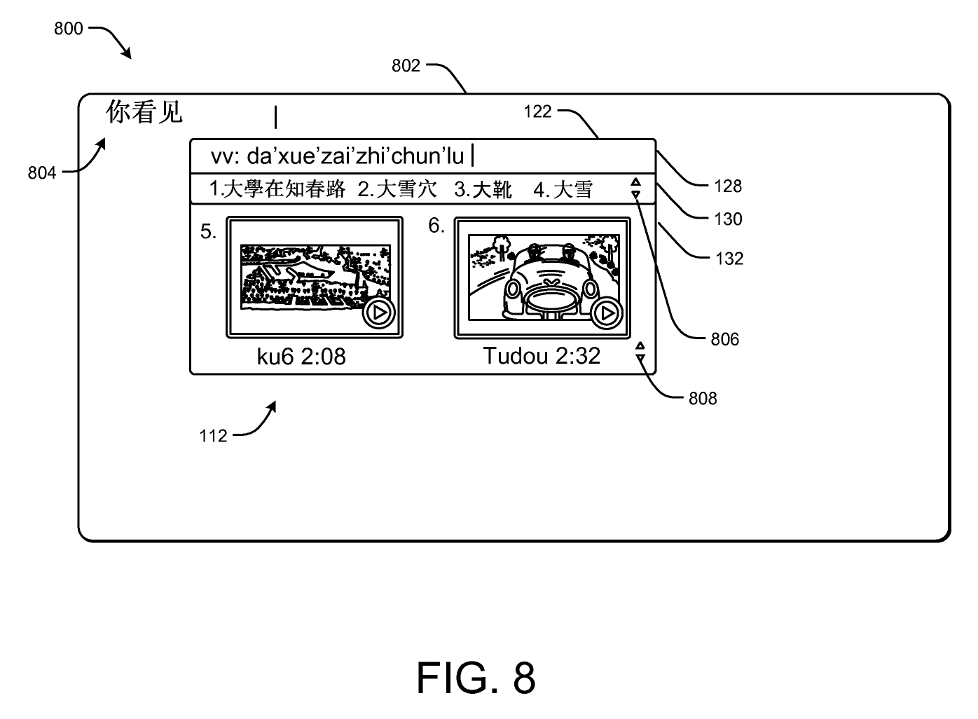

FIG. 8 is a pictorial view of a sixth example 800 of host application 802 utilizing an IME according to some implementations herein. In the illustrated example, IME 112 is again operating to insert Chinese characters into host application 802 by converting pinyin text into Chinese characters. Host application 802 is a shown here as a document-editing application. However, host application 802 may also be chatting application, a drawing application, an email application, or various other applications.

Host application 802 includes text insertion area, generally indicated by 804. Text insertion area 804 includes characters inserted by the user or via IME 112 into the host applicant. Text insertion area 804 also includes an input indication represented by “|,” which represents an indication of where the candidates are to be inserted into host application 802 by insertion manager 126. The input indication may be, for example, a focus of a mouse. The input indication also indicates which host application 802 of computer device 102 among many host applications running on computing device 102 that is to receive the candidates inserted by IME 112.

IME 112 is shown as user interface 122, which includes composition window 128 for receiving user inputs, text candidate window 130 for presenting text candidates to the user, and rich candidate window 132 for presenting rich candidate to the user. Text candidate window 130 is shown including pervious and next candidate arrows 806, which the user can interactive with to receive additional text candidates not currently shown in text candidate window 130. Rich candidate window 132 is also shown including a pervious and next candidate arrows 808, which the user can interactive with to receive additional rich candidates not currently shown in rich candidate window 132.

In the illustrated example, the user has entered the character “vv: da′xue′zai′zhi′chun′lu”. As a result of the user entering “vv:”, IME 112 is in video mode. While in video mode, text candidate window 130 continues to translate the pinyin text “da′xue′zai′zhi′chun′lu” into Chinese characters as discussed above. On the other hand, rich candidate window 132 presents videos related to the pinyin text “da′ xue′zai′zhi′chun′lu”.

In some examples, the user may cause IME 112 to insert either the Chinese characters indicated in text candidate window 130 into host application 802 at text insertion area 804 by entering “1”, “2”, “3”, “4” or a playable video clip as shown in rich candidate window 132 by entering or “5” or “6”. If host application 802 is unable to receive a video clip, IME 112 may convert the video clip into an image, such as the image displayed on the start screen of the video or to a series of images taken from the video clip and representative of the video clip.

Example methods for performing techniques described herein are discussed in detail below. These example methods can be described in the general context of computer executable instructions. Generally, computer executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network or a communication cloud. In a distributed computing environment, computer executable instructions may be located both in local and remote memories.

The example methods are sometimes illustrated as a collection of blocks in a logical flow graph representing a sequence of operations that can be implemented in hardware, software, firmware, or a combination thereof The order in which the methods are described is not intended to be construed as a limitation, and any number of the described method blocks can be combined in any order to implement the methods, or alternate methods. Additionally, individual operations may be omitted from the methods without departing from the spirit and scope of the subject matter described herein. In the context of software, the blocks represent computer executable instructions that, when executed by one or more processors, perform the recited operations.

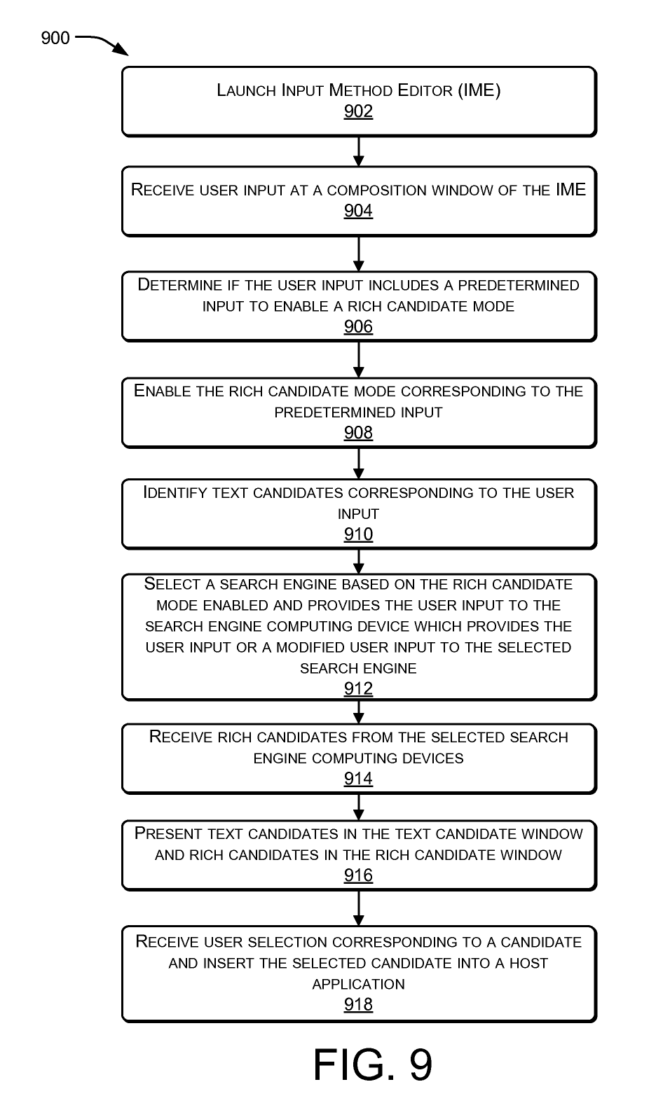

FIG. 9 is a flow diagram of an example process 800 preformed by IME 112 of FIG. 1. At 902, IME 112 is launched from a host application (such as host applications 302, 402, 502, 602, 702, or 802). IME 112 is configured to assist a user with regards to inserting text and/or multimedia inputs into the host application. In one example, IME 112 may be utilized to provide an auto complete or spell check function of the text to provide candidates for insertion into the host application. For example, IME 112 may be utilized with a texting or email application on a smart phone or tablet where a full keyboard is unavailable to the user to provide a typing aid. In another example, IME 112 may be utilized to translate Latin script characters into other non-Latin scripts such as Arabic or Chinese. One typical use of IME 112 is to convert pinyin text entered by a user into Chinese characters before insertion into the host application.

At 904, IME 112 receives user input at a composition window 128. In various examples, IME 112 may receive user inputs from a keyboard, a microphone or voice input mechanism, a mouse, a touch screen and/or a combination of the above mentioned.

At 906, IME 112 determines if the user input includes a predetermined input to enable a rich candidate mode. IME 112 is configured to include multiple rich candidate modes, which the user may activate or enable by entering a predetermined input or series of inputs. For example, IME 112 may be configured with a web mode that allows IME 112 to communicate with one or more search engines over a network and to present the search results as rich candidates to the user. In another example, IME 112 may be configured with a video mode that allows IME 112 to communicate with a search engine computing device over the network and to present the video search results as rich candidates to the user. In yet another example, IME 112 may be configured with a map mode that allows IME 112 to communicate with a search engine computing devices over the network and to present an interactive map and location indicators as rich candidates to the user. In yet another example, IME 112 may be configured with an image mode that allows IME 112 to communicate with a search engine computing devices over the network and to present images as rich candidates to the user. In yet another example, IME 112 may be configured with an audio mode that allows IME 112 to communicate with a search engine computing devices over the network and to present audio files as rich candidates to the user.

At 908, IME 112 enables the rich candidate mode corresponding to the predetermined input. Each rich candidate mode can be activated or enabled using a different predetermined input or combination of inputs. For example, inputting the character “v” at composition window 128 may cause IME 112 to enter rich candidate mode and/or present the user with a rich candidate mode menu. In another example, entering “vw” may cause IME 112 to enter web mode. Various other combinations such as “vv” for video mode, “vm” for map mode, “vi” for image mode, and “va” for audio mode may also be implemented by IME 112. Additional rich candidate modes may be incorporated into IME 112 and enabled using additional predetermined inputs or combination of inputs. In one example, multiple rich candidate modes may be enabled in combination by entering additional predetermined inputs. For example, IME 112 may enter a combined image mode and video mode when the user enters “viv:” or “vvi:”. By utilizing combinations of modes, IME 112 can present to the user rich candidates in multiple forms increasing the ease of use for the user.

At 910, IME 112 identifies text candidates corresponding to the user inputs. For example, IME 112 may identify auto complete, spell checking, translations, or suggested text based on the user input. IME 112 may also present the rich candidate menu as the text candidates to the user in response to the user entering a predetermined input.

At 912, IME 112 selects a search engine based on the rich candidate mode enabled and provides the user input to the search engine computing device which provides the user input or a modified user input to the selected search engine. The search engine may be one or more search engines selected by IME 112 or by a user through a search engine menu.

IME 112 may also provide additional data to the one or more search engines along with the user inputs to help the one or more search engine to further narrow or more accurately target the search results. For example, IME 112 may provide additional data indication the type of searches to be performed by the search engines to the search engine computing devices. IME 112 may also provide other types of data such as segments of inserted text, data related to the host application, the type of candidates that are accepted by the host application, data related to the computing device executing the host application, data related to previous user inputs, data related to user search history, data related to previous presented candidates and/or data related to previous inserted candidates.

At 914, IME 112 receives rich candidates from the search engine computing devices. At this time, IME 112 may further order the search results beyond the order provided by the search engine and the search engine computing device. IME 112 is able to further order the rich candidates by collecting, correlating, and analyzing previous user inputs and corresponding candidate insertions with the current user input and rich candidates returned from the search engine. In one particular example, IME 112 may correlate and analyze user inputs with user inputs entered by others via a server system in communication with IME 112 through communication interfaces 106.

At 916, IME 112 presents the text candidates in the text candidate window and the rich candidates in the rich candidate window. Each candidate is presented to the user with a corresponding insertion key. For example, each candidate may include a numerical reference, which the user may enter in composition window 128 to cause IME 112 to insert the candidate into the host application. At 918, IME 112 receives user selection at the composition window corresponding to a candidate and inserts the selected candidate into the host application. IME 112 is aware of the type of candidates that may be inserted and accepted by the host application. Thus, IME 112 may convert the candidates into other types of candidates, such that the candidate can then be inserted into the host application. For example, the host application may be a document-editing application and the rich candidate may be an interactive map. IME 112 may then convert the interactive map into an image file, such as a jpeg file, before inserting it into the host application.

Once, IME 112 has inserted a candidate into the host application, IME 112 may clear composition window 128 and await the next user input. IME 112 may also return to normal mode or may remain in the last selected rich candidate mode following the insertion.

### CONCLUSION

Examples of an IME capable of presenting rich candidates to a user in a rich candidate window are described above. In some examples, multiple rich candidate modes are available, such as a web mode, image mode, map mode, and video mode. In some of the examples, the user is able to select a rich candidate mode by entering predetermined inputs into a composition window of the IME. In other examples, a rich candidate mode menu is presented to the user for selection of a rich candidate mode. In one particular example, the IME is able to utilize one or more search engines to locate the rich candidates for presentation to the user.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A computer-readable storage media storing instructions that, when executed by one or more processors, cause the one or more processors to generate a graphical user interface (GUI) for an input method editor (IME), the GUI including:
a composition window to receive user inputs,
a text candidate window to present at least one text candidate, and
a rich candidate window to present at least one rich candidate while the IME is in a rich candidate mode.

2. The computer-readable storage media of claim 1, further comprising instructions that when executed by the one or more processors, cause the one or more processors to enable the rich candidate mode of the IME in response to detecting a predetermined user input.

3. The computer-readable storage media of claim 1, wherein the GUI further includes a rich candidate menu, the rich candidate menu including user selectable options corresponding to a plurality of rich candidate modes.

4. The computer-readable storage media of claim 1, wherein the IME provides the user input to a search engine and receives the at least one rich candidate from the search engine in response.

5. The computer-readable storage media of claim 4, wherein the search engine is user selectable.

6. The computer-readable storage media of claim 4, wherein the IME further ranks and orders the at least one rich candidate based in part on historical data related to user candidate selections.

7. The computer-readable storage media of claim 1, wherein the rich candidate mode is at least one of a web mode, a map mode, a video mode, an audio file mode, or an image mode.

8. The computer-readable storage media of claim 1, wherein the at least one rich candidate include at least one of a link to a website, a map, a video file, an audio file, or an image.

9. A system comprising:
one or more processors; and
one or more computer-readable storage media storing instructions that, when executed by one or more processors, causes the one or more processors to provide an input method editor (IME) within a host application, the IME including a normal mode and a rich candidate mode, the IME to present:
text candidates in response to receiving user inputs in the normal mode, and
rich text candidates, in addition to the text candidates, in response to receiving user inputs in the rich candidate mode.

10. The system of claim 9, wherein the IME enters the rich candidate mode in response to receiving a mode prefix string.

11. The system of claim 9, wherein the IME includes a graphical user interface (GUI), the GUI including a composition window to receive user inputs, a text candidate window to present text candidates, and a rich candidate window to present rich candidates.

12. The system of claim 11, wherein the rich candidate window comprises an embedded web browser using a hypertext markup language (HTML).

13. The system of claim 9, wherein the rich candidate mode is at least one of a web mode, a map mode, a video mode, an audio mode, or an image mode.

14. A method comprising:
receiving user inputs in a composition window of an input method editor (IME);
activating a rich candidate mode in response to determining that the user inputs include a predetermined input;
identifying one or more text candidates and one or more rich candidates based at least in part on the user inputs;
presenting the one or more text candidates in a text candidate window; and
presenting the one or more rich candidates in a rich candidate window.

15. The method of claim 14, wherein the identifying one or more rich candidates further comprises:
providing the user inputs to a search engine; and
receiving the one or more rich candidates from the search engine.

16. The method of claim 14, further comprising:
receiving a user selection corresponding to at least one of the one or more text candidates and the one or more rich candidates; and
inserting the user selection into a host application.

17. The method of claim 14, wherein the rich candidate mode includes at least one of a web mode, a map mode, a video mode, an audio mode, and an image mode.

18. The method of claim 14, further comprising activating a second rich candidate mode in response to determining that the user inputs also include a second predetermined input.

19. The method of claim 14, wherein the one or more text candidates include translations of the user inputs into at least one other language.

20. The method of claim 14, wherein the one or more rich candidates include at least one of a link to a website, a map, a video file, an audio file, or an image.
